(19) United States
(12) Patent Application Publication
(10) Pub. No.: US 2006/0090293 A1
(43) Pub. Date: May 4, 2006

(54) Mobile pneumatic duct cleaning system

(76) Inventors: Michael James Nigro, Katy, TX (US); Karl Fredericks, Belleville, NJ (US)

Correspondence Address: BARBER LEGAL, P.O. BOX 16220, GOLDEN, CO, 80402-6004, US

(21) Appl. No.: 11/260,411

(22) Filed: Oct. 27, 2005

Related U.S. Application Data
(60) Provisional application No. 60/622,693, filed on Oct. 28, 2004.

(51) Int. Cl. B08B 9/02

(52) U.S. Cl. 15/406

(57) ABSTRACT

A mobile, self contained system and process for removing debris and dust from the interior of ductwork without use of rotating shafts or cables. A mobile housing and equipment unit may have a plurality of wheels which can be easily removed. Within the housing a vacuum source, debris collection plenum, air compressor and associated structures are disposed. The vacuum head has an air hose attachment point, a turbine or other pneumatic drive, a vacuum intake, and a rotating brush powered by the turbine/pneumatic drive. A first compressed air feed hose supplies compressed air from the compressor to the turbine, thus providing power to agitate or rotate the brush. A vacuum hose withdraws air from the vacuum head, thus entraining and removing debris and dust. A second compressed air feed line may supply compressed air to the turbine to drive the (reversible) turbine in the opposite direction.

### CROSS-REFERENCE TO RELATED APPLICATIONS

This application claims the priority and benefit of U.S. Provisional Patent Application No. 60/622,693 filed Oct. 28, 2004 in the names of the same inventors, Michael J. Nigro and Karl A. Frederick, and entitled MOBILE AIR DUCT AND DRYER VENT CLEANING SYSTEM.

### FIELD OF THE INVENTION

This invention relates generally to duct cleaning devices, and specifically to pneumatic duct cleaning devices.

### STATEMENT REGARDING FEDERALLY FUNDED RESEARCH

This invention was not made under contract with an agency of the US Government, nor by any agency of the US Government.

### BACKGROUND OF THE INVENTION

In structures having ducts for ventilation systems, normal use causes dust and debris to accumulated within the ducts: dust, debris, skin flakes, skin and dust mites, hair, left over construction fibers, decaying matter, pollen, bacteria, dead insects, mold and many other types of foreign matter occur in the typical ventilation system, air duct, HVAC ducting, dryer vents and so on. Obviously, individuals exposed to air which passes through the ducts may well experience health issues as a result. In addition, a sufficient accumulation of such dust and debris may actually measurably degrade the efficiency of the airflow of the system and thus the energy efficiency of the furnace, dryer, air conditioner, evaporative (“swamp”) cooler, fans, etc which use the system. These various types of ducts may have differing sizes and geometries, but they share the problem of dust and debris accumulation.

Periodic cleaning of such systems is thus a necessity.

There are a variety of methods for the cleaning of such systems. One example is a system which utilizes a hose through which a flexible rotating cable is run with a brush coupled to the flexible rotating cable. A vacuum intake closely disposed to the brush entrains and carries off dust and debris dislodged by the action of the brush. Examples of such equipment include U.S. Pat. No. 4,792,363 issued Dec. 20, 1988 and U.S. Pat. No. 5,802,667 issued Sep. 8, 1998, the latter of which also has through holes in the length of the conduit, allowing additional entrainment of air sucked in along the length of the conduit, creating additional vacuum cleaning of the duct.

However, such systems have various disadvantages. In particular, the rotating cable (or drive shaft) may rub against the interior of the vacuum hose and possibly even break it. In addition, the mechanical rotation of flexible cables in a necessarily “lossy” process having high losses of mechanical energy to flexion, to torque being channeled into angles around which the cable passes and so on. The net result is a reduced mechanical efficiency as well as a reduced vacuuming efficiency of the vacuum hose, the latter caused by the rotating and twisting cable within.

Other devices known are quite complex or use multiple machines for carrying out the brushing/agitation and the vacuum processing. Such machines tend to be less portable, require routing cables, may restrict airflow, may be costly to manufacture or use, may require special training and so on.

It would be advantageous to provide a machine which is simple to manufacture, easy to use, portable, self contained and yet carried out the functions of operator controlled brushing and vacuuming.

It would further be advantageous to provide a machine which may be easily adapted to various different types of duct work.

### SUMMARY OF THE INVENTION

General Summary

The present invention provides a mobile, self contained system and process for removing debris and dust from the interior of duct work without use of rotating shafts or cables.

Two major portions of the invention, a mobile housing and a vacuum head are connected by a flexible hose.

The mobile housing and equipment unit may have a plurality of wheels which can be easily removed. The housing and equipment unit may be light enough to be carried or rolled by hand grip on a handle. Within the housing a vacuum source, debris collection plenum, air compressor and associated structures are disposed. On the exterior of the housing, controls and an air hose attachment point may be located.

The vacuum head has an air hose attachment point, a turbine or other pneumatic drive, a vacuum intake, and a rotating brush powered by the turbine/pneumatic drive.

The flexible air hose connecting the housing and head is a “two way” hose having a first compressed air feed hose supplying compressed air from the compressor to the turbine, thus providing power to agitate or rotate the brush. A vacuum hose withdraws air from the vacuum head, thus entraining and removing debris and dust. A second compressed air feed line may supply compressed air to the turbine to drive the (reversible) turbine in the opposite direction. In alternative embodiments, reciprocating, radial or other types of pneumatic drives may be used to provide the mechanical motion of the brush, and the brush may be moved or agitated in more than one degree/dimension of motion.

Hoses, of course, are notably less expensive to manufacture than flexible drive cables or drive shafts, last longer, have no moving parts, do not rub, do not lose mechanical efficiency when they press up against a corner, and may easily be made to a length greater than the maximum length at which most drive cables can function.

### SUMMARY IN REFERENCE TO CLAIMS

It is therefore a first aspect, advantage, objective and embodiment of the invention to provide a duct cleaning apparatus comprising:
a portable housing;
a vacuum motor disposed within the portable housing, the vacuum motor providing vacuum to a vacuum hose coupling located on the portable housing;
a flexible vacuum hose; the vacuum hose having a first end operatively connected to the vacuum hose coupling; the vacuum hose having a second end having a physical attachment to a pneumatic drive;
a compressor motor disposed within the portable housing, the compressor motor operatively connected to a first compressed air feed line, the first compressed air feed line operatively connected to the pneumatic drive;
the pneumatic drive operated by compressed air from the first compressed air feed line to produce a first degree of mechanical motion; and
a brush physically connected to the pneumatic drive and mechanically moved such first degree of mechanical motion.

It is therefore a second aspect, advantage, objective and embodiment of the invention to provide a duct cleaning apparatus wherein the pneumatic drive further comprises:
a turbine operated by compressed air from the first compressed air feed line.

It is therefore another aspect, advantage, objective and embodiment of the invention to provide a duct cleaning apparatus wherein the turbine further comprises:
a turbine shaft rotated by operation of the turbine, the brush attached to such turbine shaft whereby the first degree of mechanical motion of the brush is rotation in a first direction.

It is therefore another aspect, advantage, objective and embodiment of the invention to provide a duct cleaning apparatus further comprising:
a second compressed air feed line operatively connected at a first end to the compressor motor and at a second end to the pneumatic drive.

It is therefore another aspect, advantage, objective and embodiment of the invention to provide a duct cleaning apparatus wherein the pneumatic drive comprises a multiple motion drive capable of producing a second degree of mechanical motion when driven by the second compressed air line.

It is therefore another aspect, advantage, objective and embodiment of the invention to provide a duct cleaning apparatus wherein the second degree of mechanical motion further comprises: rotation in a second direction different from the first direction.

It is therefore another aspect, advantage, objective and embodiment of the invention to provide a duct cleaning apparatus wherein the first compressed air feed line is disposed within the vacuum hose.

It is therefore another aspect, advantage, objective and embodiment of the invention to provide a duct cleaning apparatus further comprising: a vacuum nozzle physically attached to the second end of the vacuum hose.

It is therefore another aspect, advantage, objective and embodiment of the invention to provide a duct cleaning apparatus wherein the nozzle further comprises the physical attachment of the second end of the vacuum hose to the pneumatic drive.

It is therefore another aspect, advantage, objective and embodiment of the invention to provide a duct cleaning apparatus further comprising:
a debris collection plenum having a first operative vacuum connection to the vacuum supplied by the vacuum motor and having a second operative vacuum connection to the vacuum hose coupling, whereby air from the vacuum hose passes through the debris collection plenum before passing through the vacuum motor.

It is therefore another aspect, advantage, objective and embodiment of the invention to provide a duct cleaning apparatus further comprising:
a HEPA rated filter disposed so that air exiting the debris collection plenum passes through the HEPA filter.

It is therefore another aspect, advantage, objective and embodiment of the invention to provide a method of duct cleaning comprising the steps of:
a) physically attaching a brush to a pneumatic drive and operatively connecting a first end of a compressed air line to the pneumatic drive;
b) inserting a first end of a vacuum hose into such duct;
c) inserting the brush, pneumatic drive and first end of the compressed air line into such duct;
d) providing vacuum to such vacuum hose; and
e) providing compressed air to such compressed air feed line, whereby such pneumatic drive moves such brush.

It is therefore yet another aspect, advantage, objective and embodiment of the invention to provide a method of duct cleaning further comprising:
a1) physically attaching the vacuum hose to the pneumatic drive.

It is therefore yet another aspect, advantage, objective and embodiment of the invention to provide a method of duct cleaning further comprising:
a2) disposing the compressed air feed line within the vacuum hose.

It is therefore yet another aspect, advantage, objective and embodiment of the invention to provide a method of duct cleaning further comprising:
a3) providing a HEPA rated filter; and
d1) filtering vacuumed air through the HEPA rated filter.

### BRIEF DESCRIPTION OF THE DRAWINGS

FIG. 1 is a partially cross-sectional diagram of a first vacuum head embodiment of the device, a presently preferred embodiment and best mode now contemplated for carrying out the invention.

FIG. 2 is a partially cross-sectional diagram of a second vacuum head embodiment of the device having only one compressed air feed line.

FIG. 3 is a side view of a third vacuum head embodiment of the device in which the compressed air feed line(s) are external to the vacuum hose.

FIG. 4 is a side view of a fourth equipment housing embodiment of the invention.

FIG. 5 is a partially cross sectional side view of a fifth equipment housing embodiment of the invention.

### INDEX TO REFERENCE NUMERALS

Brush 1
Turbine/pneumatic drive 2
Nozzle/turbine support 3
Brackets 4
First electrical cable 5
Second electrical cable 6
Hinged lid 7
First handle 8
Vacuum motor 9
Access lid 10
Filter 11
First wheel 12
First switch 13
Second switch 14
Air compressor 15
Output connector 16
Third compressed air feed line 17
Input valve connector 18
Output valve connector 19
Second compressed air feed line 20
First compressed air feed line 22
Forward output connector 23
Air valve 24
Air valve switch 25
Air seal 26
Vacuum inlet opening 27
Hose intake 28
Hose coupler 29
Vacuum hose 30
Second wheel 31
Debris collection plenum 32
Compressor plenum 33
Vacuum motor plenum 34
Housing 35
Vacuum chamber wall 36

### DETAILED DESCRIPTION

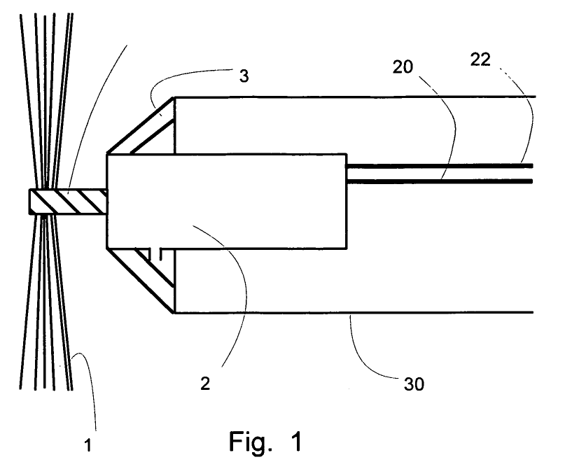

FIG. 1 is a partially cross-sectional diagram of a first vacuum head embodiment of the device, a presently preferred embodiment and best mode now contemplated for carrying out the invention. Brush 1 may be of any suitable configuration for duct cleaning: round, elongated, etc, and may be a bristle brush or other stiff brush or may in embodiments be a softer brush or buffer, depending upon the nature of the duct interior and the debris and dust to be found in the duct.

Turbine/pneumatic drive 2 may advantageously be a turbine, however, the invention is not so limited. The pneumatic drive 2 may be a rotary device, a reciprocating device and so on. The pneumatic drive 2 may be operated by application of compressed air to produce mechanical motion of a shaft, chain or similar structure which may in turn power brush 1 to move. The range of degrees of motion is not limited: the brush may be moved in embodiments in three dimensions, two directions each, and in three axes of rotation, both forward and backward, and may also move in a combination of such degrees of motion. The pneumatic drive 2 may be reversible so that application of compressed air in one direction produces a first degree direction of motion while application of compressed air in another direction produces a second degree of motion in the opposite direction. In one preferred embodiment, pneumatic drive 2 may cause brush 1 to rotate, and by reversing the pneumatic drive 2, the brush 1 may rotate in the opposite direction. In other embodiments, brush 1 may automatically agitate in different types of motion, for example, rotating while moving back and forth, based upon the design of pneumatic drive 2.

Application of compressed air in different ways to pneumatic drive 2 may be produced by multiple compressed air feed lines 22, 20. First and second compressed air feed lines 22, 20 may be controlled by valves located at the main equipment housing unit, allowing an operator or an automatic control device to easily change the motion of the brush 1.

Vacuum hose 30 may be a standard hose of types commonly used in the industry or may be of a customized type. In the best modes now contemplated, the vacuum hose 30 may serve as the support and motive force for the entire vacuum head assembly: when the operator pushes vacuum hose 30 further into the duct, the entire head moves, drive, brush and all.

Nozzle/turbine support 3 may be either a vacuum nozzle or a support for the pneumatic drive or may serve both functions as in the preferred embodiment. Thus when vacuum hose 30 is urged deeper into the ductwork, pneumatic drive 2 and brush 1 will also be forced further into the ductwork. Brush 1 further serves the beneficial purpose of tending to keep vacuum hose 30 aligned near the centerline of the duct. Various geometries of nozzles and supports may be used.

Compressed air lines 22, 20 may in the presently preferred embodiment be disposed within vacuum hose 30, thus greatly reducing drag on the head as it is pushed into the duct and serving to protect the compressed air lines 22, 20 and help prevent kinks in either the compressed air lines 22, 20 or the vacuum hose 30.

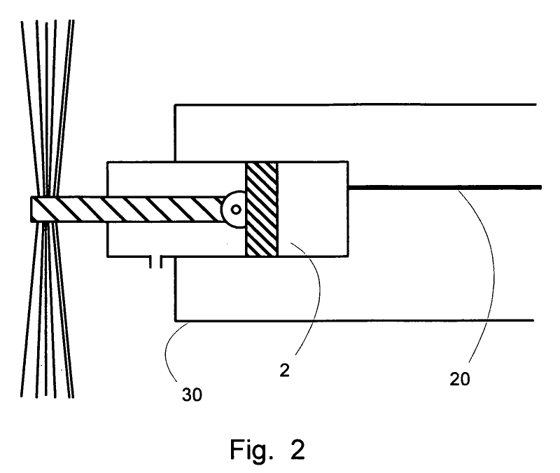

FIG. 2 is a partially cross-sectional diagram of a second vacuum head embodiment of the device having only one compressed air feed line. In this embodiment, the pneumatic drive 2 may be of a type which responds to fluctuations in pressure when altering the type of motion generated. For example, pneumatic drives are made which may sense a short cessation of compressed air and respond by automatically changing direction when the single air line resumes feeding air in the original direction. In alternative embodiments of reduced cost, the pneumatic drive 2 may simply always produce the same degree of motion (rotation in the clock-wise direction, for example, or back and forth agitation) and yet produce satisfactory cleaning of duct interiors. Thus reciprocating drives may be used.

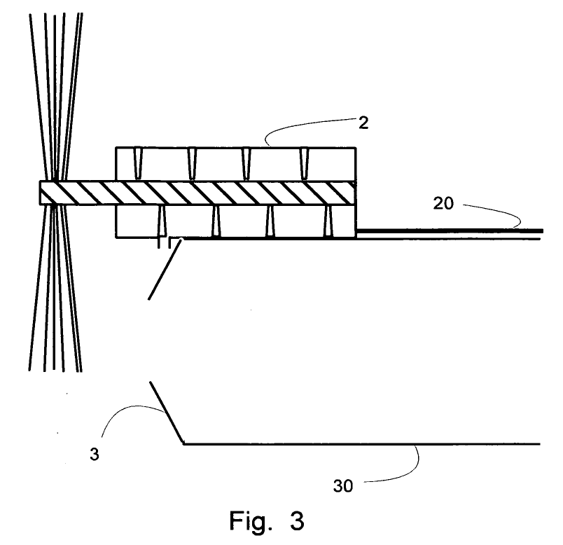

FIG. 3 is a side view of a third vacuum head embodiment of the device in which the compressed air feed line(s) are external to the vacuum hose. This embodiment may provide for simpler manufacturing as it allows simpler construction of the housing, hose and air lines, however, the preferred embodiment is as discussed in reference to FIG. 1.

As shown in FIG. 3, turbine drives may be advantageously employed. The pneumatic drive, regardless of type, may be located in a variety of locations relative to the vacuum hose 30: inside, outside, at the nozzle, projecting beyond the nozzle, or separated. The vent from the drive to the exterior may be disposed within the vacuum tube or without.

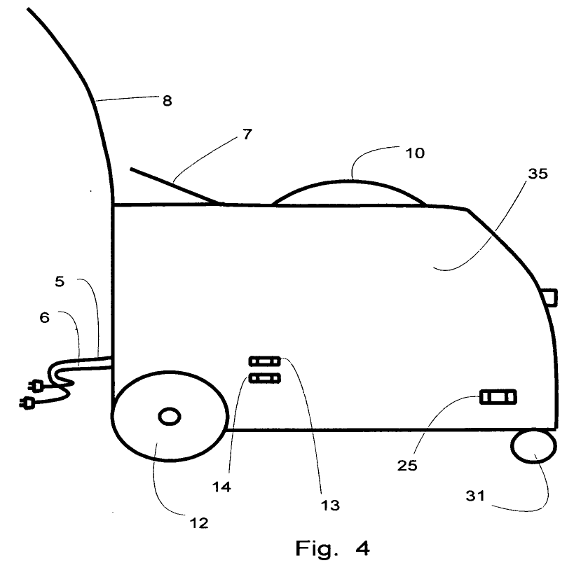

FIG. 4 is a side view of a fourth equipment housing embodiment of the invention. The exterior of the equipment housing has first and second electrical cables 5, 6. In practice, the device may be expected to be used in residential settings in which large amounts of drawn current may be unavailable. As both the vacuum and the air compressor draw large amounts of current, two cables may be preferable, allowing dispersion of the load over different circuits of a home, office, or small business. In addition, many air compressors and vacuums as used within the housing may have their own cords adapted for their own use (for example a 240 VAC cord for one item but a 120 VAC cord for the other) and so different cords may be more easily implemented or simply required.

Hinged lid 7 allows access to the interior of the housing 35 in one location while access lid 10 may allow access in another location. Access to the interior may be necessary to allow removal of debris collected, to change HEPA filters, for repairs and so on.

First handle 8 may be mounted so as to allow the device to be easily rolled (off center and elongated) or it may be mounted so as to allow for carrying in lighter versions of the device (above the center of gravity). In testing, the size of the unit has been found to be such that rolling in a manner analogous to a furniture dolly is usually preferable to hand carrying. Thus first wheel 12 may be large, making it easier to wheel the device over carpet, lintels, steps, stairs, lawn and the like. Second wheel 31 may be smaller. Any wheels of the device may be removable to allow easier hand carrying.

First switch 13 may control electrical supply from the cord 5 or 6 to vacuum, while second switch 14 may control electrical supply to the air compressor. One switch may be used for both functions, however, for flexibility of use two switches are desirable. In addition, the switches may be variable, allowing different degrees of vacuum or air compression as desirable.

Air valve switch 25 is not an electrical switch but a control valve determining which of the two compressed air feed lines receives compressed air. This valve and switch allow the operator to change from one type of brush motion to another type at the flip of a switch conveniently located on the equipment housing, right to hand for the operator. This may have an externally protruding portion allowing easy access for control, but the main valve body of the switch may be inside the housing 35.

Housing 35 may be metal, wood, high strength polymer, composite or the like. It is structurally sound enough to withstand the weight of the compressor and vacuum inside it and the abuse of continuous relocation to new locations for duct cleaning. It is also air tight in portions, allowing the vacuum generated by the vacuum motor to suck debris into an internal plenum. It may have circulation vents to allow free air flow to other locations however, in particular, the vacuum motor and air compressor should have free air flow to them.

In alternative embodiments, housing 35 may in fact be eliminated. The air compressor and vacuum motor may be attached to a wheeled framework or the like instead.

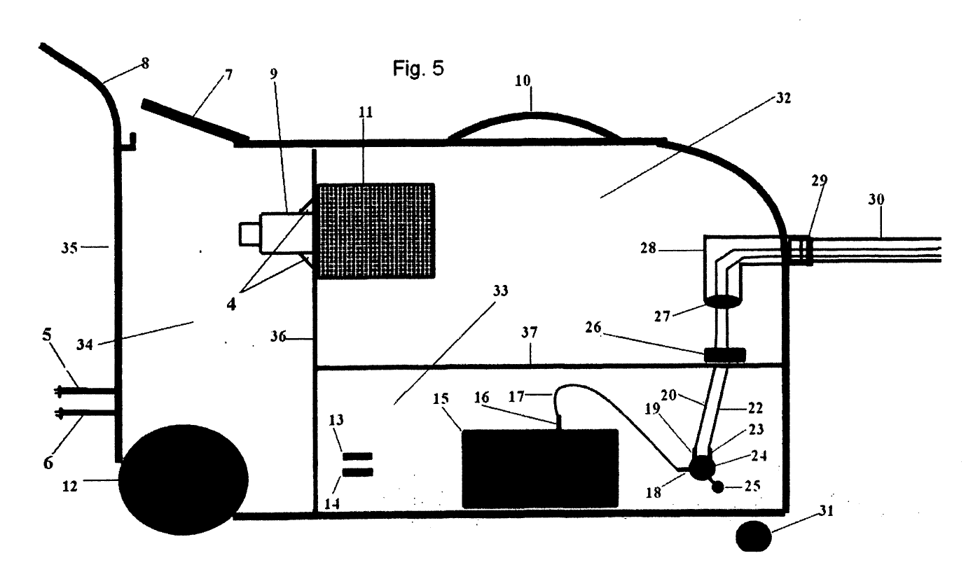

FIG. 5 is a partially cross sectional side view of a fifth equipment housing embodiment of the invention.

Brackets 4 hold vacuum motor 9 onto vacuum chamber/debris collection plenum wall 36. First electrical cable 5 and second electrical cable 6 provide electrical power as noted, penetrating through the housing 35 to the interior equipment.

Vacuum motor 9 may be a standard commercial vacuum motor or may be a custom design for the application. Filter 11 may serve several purposes: it may prevent damage to the vacuum motor from grit or objects entrained and brought into the debris collection plenum/vacuum chamber 32. However, by providing a HEPA rated filter, the air exhausted from the device may be made cleaner than the air coming in, a sanitary measure and a safety measure.

Air compressor 15 may also be a standard air compressor as known in the art, or may be customized for the application. In practice, smaller air compressors are desirable for weight reasons, however, the air compressor 15 should be of a capacity to properly serve pneumatic drive 2. Sound baffling of compressor plenum 33 may in embodiments be provided to help deal with the substantial noise of the air compressor, or a relatively quiet type of air compressor may be used. Such sound insulation should not interfere with the inflow of air to the compressor 15.

Output connector 16 allows compressed air from compressor 15 to pass to third compressed air feed line 17, which in turn is connected to input valve connector 18 of air valve 24, the valve allowing compressed air feed to multiple different lines to the pneumatic drive via output valve connector 19 to second compressed air feed line 20 to first compressed air feed line 22 via forward output connector 23. As commented, air valve switch 25 may be located on the outside of the equipment housing 35 for convenient use.

Air seal 26 allows the compressed air lines 22, 20 to pass through into the debris collection plenum 32 without allowing air to pass into the chamber/plenum itself.

Vacuum inlet opening 27 provides access to the plenum 32 for air and entrained waste coming down vacuum hose 30. The size of the chamber/plenum in comparison to the cross sectional area of the vacuum hose 30 means that air entering the plenum 32 immediately slows and reduces pressure. This has the desirable effect of cooling the air but the primary purpose is to cause the slower, thinner air to “drop” entrained particles and debris.

Hose intake 28 is the internal end of the conduit or flow path created by the vacuum hose 30, it may be the same size as vacuum hose 30 in cross sectional area or it may be smaller or larger.

Hose coupler 29 allows easy attachment and removal of vacuum hose 30 along with associated compressed air lines 22, 20, thus greatly aiding portability and allowing interchange of different vacuum heads, hose lengths, hose diameters, hose materials, types of compressed air feed lines and the like.

Vacuum motor plenum 34 allows vacuum motor 9 to sit in a separate chamber from air compressor 15, aiding the use of clean air for the compressor and cooled air for the vacuum motor 9, and preventing potentially undesirable recirculation.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A duct cleaning apparatus comprising:
a vacuum motor providing vacuum to a vacuum hose coupling;
a flexible vacuum hose; the vacuum hose having a first end operatively connected to the vacuum hose coupling; the vacuum hose having a second end having a physical attachment to a pneumatic drive;
a compressor motor operatively connected to a first compressed air feed line, the first compressed air feed line operatively connected to the pneumatic drive;
the pneumatic drive operated by compressed air from the first compressed air feed line to produce a first degree of mechanical motion; and
a brush physically connected to the pneumatic drive and mechanically moved by such first degree of mechanical motion.

2. The duct cleaning apparatus of claim 1, further comprising:
a portable housing, wherein the air compressor and vacuum motor are disposed within the portable housing, and wherein the vacuum hose coupling is disposed upon the portable housing.

3. The duct cleaning apparatus of claim 1, wherein the pneumatic drive further comprises:
a turbine operated by compressed air from the first compressed air feed line.

4. The air cleaning apparatus of claim 3, wherein the turbine further comprises:
a turbine shaft rotated by operation of the turbine, the brush attached to such turbine shaft whereby the first degree of mechanical motion of the brush is rotation in a first direction.

5. The duct cleaning apparatus of claim 1, further comprising:
a second compressed air feed line operatively connected at a first end to the compressor motor and at a second end to the pneumatic drive.

6. The duct cleaning apparatus of claim 5, wherein the pneumatic drive comprises a multiple motion drive capable of producing a second degree of mechanical motion when driven by the second compressed air line.

7. The duct cleaning apparatus of claim 6, wherein the second degree of mechanical motion further comprises: rotation in a second direction different from the first direction.

8. The duct cleaning apparatus of claim 1, wherein the first compressed air feed line is disposed within the vacuum hose.

9. The duct cleaning apparatus of claim 1, wherein the first compressed air feed line is disposed outside of the vacuum hose.

10. The duct cleaning apparatus of claim 1, further comprising: a vacuum nozzle physically attached to the second end of the vacuum hose.

11. The duct cleaning apparatus of claim 10, wherein the nozzle further comprises the physical attachment of the second end of the vacuum hose to the pneumatic drive.

12. The duct cleaning apparatus of claim 1, further comprising:
a debris collection plenum having a first operative vacuum connection to the vacuum supplied by the vacuum motor and having a second operative vacuum connection to the vacuum hose coupling, whereby air from the vacuum hose passes through the debris collection plenum before passing through the vacuum motor.

13. The duct cleaning apparatus of claim 12, further comprising:
a HEPA rated filter disposed so that air exiting the debris collection plenum passes through the HEPA filter.

14. A method of duct cleaning comprising the steps of:
a) physically attaching a brush to a pneumatic drive and operatively connecting a first end of a compressed air line to the pneumatic drive;
b) inserting a first end of a vacuum hose into such duct;
c) inserting the brush, pneumatic drive and first end of the compressed air line into such duct;
d) providing vacuum to such vacuum hose; and
e) providing compressed air to such compressed air feed line, whereby such pneumatic drive moves such brush.

15. The method of cleaning a duct of claim 14, further comprising:
a1) physically attaching the vacuum hose to the pneumatic drive.

16. The method of cleaning a duct of claim 15, further comprising:
a2) disposing the compressed air feed line within the vacuum hose.

17. The method of cleaning a duct of claim 14, further comprising:
a3) providing a HEPA rated filter; and
d1) filtering vacuumed air through the HEPA rated filter.
